(19) United States
(12) Patent Application Publication
(10) Pub. No.: US 2004/0154027 A1
(43) Pub. Date: Aug. 5, 2004

(54) Method and means for managing communications between local and remote objects in an object oriented client server system in which a client application invokes a local object as a proxy for a remote object on the server

(76) Inventors: Jean-Jacques Vandewalle, Marseille (FR); Eric Vetillard, Marseille (FR); Patrick George, Redwood City, CA (US)

Correspondence Address: STEPHEN M. KNALLER, SUITE 445, 1350 OLD BAYSHORE HIGHWAY, BURLINGAME, CA, 94010, US

(21) Appl. No.: 10/665,905

(22) Filed: Sep. 15, 2003

Related U.S. Application Data
(63) Continuation of application No. 09/172,942, filed on Oct. 14, 1998, now abandoned.

(51) Int. Cl. G06F 9/44; G06K 19/02

(52) U.S. Cl. 719/330; 719/315; 902/26

(57) ABSTRACT

A method for managing communications between local and remote objects in an object oriented client server system in which a client application invokes a focal object as a proxy for a remote object on the server. The local object at the client and the run time environment at the server operate as stubs to form process level calls and returns and avoid byte string level message management

### FIELD OF THE INVENTION

This invention relates to object oriented client-server systems, and more particularly, to protocols effectuating exchanges among communicating objects on chip or smart card based virtual machines (severs) and counterparts on terminals or the like (clients ) to which the cards may be coupled

### DESCRIPTION OF RELATED ART

Miniaturization & Smart Cards

In the past several decades as computers have become miniaturized and memory has become denser, raw computing power itself has increased, This has lead to placing computers everywhere from traditional laboratories and offices to automobiles, vacuum cleaners, and wallet sized credit cards. The latter denominated “smart cards” are complete computing platforms in their own right, with processor, local memory, and communications facilities. Smart cards are intended to be interactive with other computers. In this sense, they are used as part of a network of interactive computers organized as clients and servers. Smart cards are associated with authorization or identification (badge reader) applications, financial truncations (automated tellers) and an ever-increasing number of like uses. They are manifest as microprocessor (chip) cards, integrated memory cards, and optical memory cards. In this specification, consideration is focused on chip cards. Since a smart (chip) card can be embedded with a microprocessor and a memory chip, it can add, delete, and otherwise manipulate information on the card, Indeed, current chip cards have the processing power and local memory capacity of the original IBM XT computer.

Client Server Applications Smart Cards, Traditional Languages, Object Oriented Architecture, & Java

It should be appreciated that interactive client/server applications involving smart cards have been expressed in object oriented architecture and programming (OOPS). Part of the rationale for an OOPS architecture is that applications and functions are easier to design and maintain and provide modularity, encapsulation, and information hiding. There are several OOPS languages such as C++ and SmallTalk. One object oriented language-processing system based on C++ but specially designed for client server and internet applications is Java. The Java language was originally created by Sun Microsystems and was designed specifically to be platform independent.

It should be appreciated that traditional or procedurally oriented programming languages are compiled to machine level binary code specific to the machine or platform on which it is to be run or executed The advantage is that compiled binary runs quickly because it is being executed in the machine's native language. However, a program written in a procedural language has to be compiled to binary code for each distinctive hardware platform. While interpreted programming languages such as APL are machine neutral and can be run without reapplication on various platforms, they are very instruction intensive and run extremely slowly.

The Java language system includes a platform specific layer, called the Java Virtual Machine, which interfaces between the hardware and Java program. The Java virtual machine presents the same interface to any applets that execute on the system. In this specification, the term “applets” and “applications” are two types of Java programs. Applets are Java programs that are usually embedded in a hypertext markup language (HTML) formatted page and can be communicated from one platform to another. Relatedly, a Java capable browser on a platform executes applets. In contrast, applications are full-fledged programs written in Java. While applications do not require a Java capable brewer, they do require the presence of a Java virtual machine.

Smart Cards & Java Card Architecture

It should be further appreciated that smart cards have the evolved from simple dedicated devices to open computing platforms. Indeed, one form of this card denominated as the “Java card” has its own architecture, application programmable interface (API), and run-time environment (JCRE). In this regard, the Java card is definable as a smart card capable of running programs written in Java, Fortunately, there exists a set of standards promulgated by the International Standard Organization in ISO 7816 parts 1-7 that cover various aspects of smart cards including the Java card Normally, the smart card does not contain a power supply display, or keyboard

The card interacts with the outside world using a serial communications interface to a system of contact points Operationally, a smart card is inserted into a card acceptance device such as a terminal, reader or interface device. The terminal is usually connected to another computer or a computer network, The terminal supplies the card path power and establishes a communications data connection.

The Java card comprises a layered architecture in which the Java card virtual machine (JCVM) resides on top of a specific integrated circuit processor and native operating system. The Java card framework includes a set of API classes for developing Java card functions and for providing systems services to those functions. The Java card functions are expressed as Java applets.

A Java card comes into existence with a native operating system, JCVM, API classes and libraries and applets are burned into a ROM. After this, the card must be initialized and personalized.

Aspects of Java Card Communication

In typical smart card applications, the communications between the card application and client is defined by commands to the card and responses from the card embedded in Application Program Data Units (APDU), APDU's arbitrarily level data structures (byte strings) that Art trace parted in the form of transport protocol data units (TPDU's) according to the ISO 7816-3 smart card protocol and standard. According to the Java card architecture, in card application communicates with the outside world through an instance (object) of the class “javacard.famework.Applet”. This class provides a method to process command APDU's. Also, Java card applets are objects residing in a different machine from the application residing in the terminal

As previously mentioned, in the Java card architecture, terminal and card programs form a client server system where communications is defined by exchanges of the previously mentioned low level communication packets (APDU's). In such a client server system the terminal application of (client) requests operations to be performed by the card applet (server). These are accomplished through an exchange of APDU's This communication scheme is a typical synchronous request-reply protocol in which the client process remain suspended until a reply arrives from the server In the Java card architecture, special acknowledgment messages are not required because a server's reply message is regarded as an acknowledgment of the client's request message.

Unfortunately, the Java card specification describes a limited version of the Java language and platform tuned to smart cards and legacy applications. A legacy application is one in which existing client applications on terminals cannot be changed and will continue to do communicate through already defined APDU's. Such architecture forces a programmer to design a proprietary protocol for every application. Also, the present Java card architecture operationally requires that both the client program and the card applets process their methods and messages exclusively the form of byte level strings and code. This adversely affects application development. First, it forces programmer's to design low-level byte string structures and protocols for each application. Second, it distracts from focusing on the object design of the whole application.

### SUMMARY OF THE INVENTION

Is accordingly an object of this invention to devise computationally efficient high level protocols among communicating objects in an object oriented client server system.

It is a related object that such high level protocols be adapted for execution in a distributed system comprising at least one smart card with a Java card virtual machine (server) and at least one card acceptance device or terminal (client) running under a Java virtual machine or the like.

It is yet another object that such high level protocols be manifest as procedure calls and returns and requiring modest modification of the existing JCVM

The above objects are believed satisfied by a method for managing information exchanges among communicating objects in an objects oriented client server system. The system includes first and second object oriented virtual machines running on counterpart first and second computers in respective server and client rules and a communication path connection between the computers. The server virtual machine also sports a run-time environment. The method of the invention involves generating a local object at the client machine operable as a proxy to a remote object resident at the server machine The method further involves referencing the local object by an application executing at the client machine and causing the local object to marshal parameters and send a process level call request to the server machine Next, responsive to the request by the server machine's run time environment, the run time environment causes the parameters in the request to become unmarshaled, the remote object to be executed, The results of the execution marshaled, and a process level return sent to the client machine. Lastly, responsive to the reply by the local object operable as a proxy, unmarshaling the results from the reply.

More particularly, in a Java based object oriented client'server, smart card and terminal system, it is necessary to create a card applet proxy as an instantiation of a utility (interface description) in the applet class of interest over standard communicating API's. From a client application point of view, the code needed to communicate with the card applet is encapsulated in the proxy. Second, a client application invokes methods of interest through the proxy. That is, the proxy prepares a process level call invoke applet message with the parameter values provided by the client application, Next the proxy sends this call to the Java card through the API, a communications module to the Java card run-time environment (JCRE). The JCRE unmarshals the parameters and invokes the methods of the applet with a local call. After execution of the methods, the results are marshaled and the JCFE prepares a process level reply message and sends the return as a reply over the inverse path to the applet proxy at the client machine.

### BRIEF DESCRIPTION OF THE DRAWING

FIGS. 1A and 1B depict client server communications relations as expressed in a smart card and terminal system according to the prior art.

FIG. 2 shows a layered view of prior art Java card software architecture.

FIG. 3A sets out structure of a prior art Java card virtual machine, FIG. 3B illustrates a Java virtual card & terminal architecture emphasizing interface, DMI, and proxy constructs according to the invention, FIG. 3C shows a Java card and terminal emphasizing proxy and interfaces.

FIG. 4 depicts an event trace diagram for a remote procedure call in an object oriented client server system using stubs according to the prior art (FIG. 3.2,p19,refA).

FIG. 5 illustrates an event trace diagram for a direct method invocation (DMI) in a Java card based client server system using interfaces, proxies and applets according to the invention.

### DESCRIPTION OF THE PREFERRED EMBODIMENT

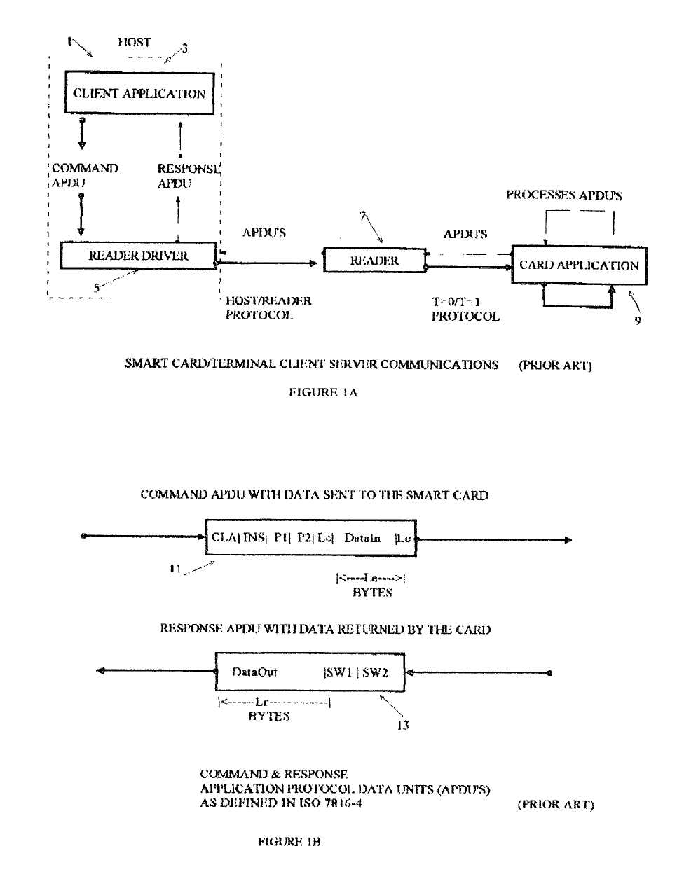

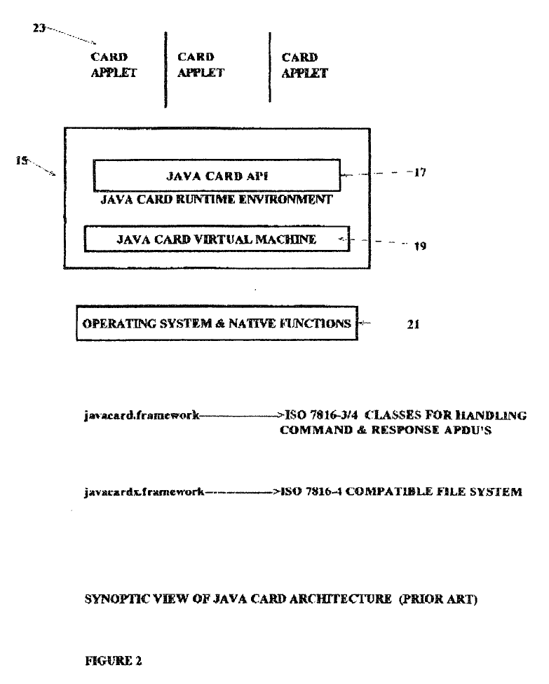

Referring now to FIG. 1A, there is shown a smart card/terminal, client/server communications arrangement well appreciated in the prior art. The arrangement includes usually a CPU host 1 interacting with a smart card 9. In this regard, the smart card 9 is coupled to a bilateral reader/transceiver 7. The reader 7 communicates messages from the host 1 to the card 9 with the messages being formatted and the communication protocols being specified according to The International Standards Organization specification ISO 7816-4. In this arrangement, card 9 acts as a server while the application 3 running on the CPU host 1 is the client. The client application 3 executing on the host 1 obtains access to the server 9 via command messages denominated Command Application Program Data Units (APDU's). The command APDU's are sent by a reader driver 5 to the server card 9 by a way of the reader/transceiver 7. In turn, the card application processes the APDU's, formats a response APDU with data and sends it the response to the application 3 over the same return path.

In the card world, the client/server model is used. This model mandates that the smart card always plays the passive role. That is, the smart card always waits for a command APDU from the terminal It then executes the action specified in the APDU and replies to the terminal with a response APDU Command and response APDU's are alternately exchange between a card and the terminal.

Referring now to FIG. 1B together with FIG. 1A, there is shown the format of APDU's as expressed in the ISO standard. It should be appreciated that the APDU's are very low level string of bytes data structures. The command APDU 11 includes a command or class designation CLA, an instruction code INS, parameters whose interpretation depends on the instruction, and a string of bytes as data to be interpreted according to INS. The length Le refers to the number of bytes, which are transmitted with the command. The response APDU 13 from the server card 9 is Lr bytes in length and includes a string of bytes DataOut, and selected status bytes SW1 and SW2. The APDU's are transported according to various wellknown protocols such as the T=0/T=1 protocol in provided by ISO 7816-3. In the Java card 9, a card application communicates externally more through an instance of the class “javacard.framework-Applet”.

Referring now to FIG. 2, there is shown a layered view of Java card software architecture. In this regard, a Java card is simply defined as a smart card capable of running Java programs. The Java card virtual machine 19 hiatus the lower level operating system and machine language functions 21 native to the to the processor chip on the card. The virtual machine in includes an interpreter of a subset of the Java byte code. It does not include dynamic class loading, a security manager, the threads and synchronization, object cloning, garbage collection etc. The card further includes an application programming interface (API) 17 and a Java card run-time environment (JCRE). Card applets 23 are stored as part of the class structure resident in the card The Class structure further includes “javacard.framework” and “javacardx-framework” implementing ISO standard 7816-3/4 command and response APOU processing and a compatible file system.

Unlike the Java virtual machine at a terminal, the Java card virtual machine runs forever. That is, the information on the card must be preserved when the power is removed. In this regard, contemporary practice involves the Java card virtual machine creating objects in a persistent and rewritable memory. Relatedly the applet life cycle on a Java card starts when the applet is properly installed and registered in the system is registry table and terminates when it is removed from the table. The applets 23 on the card 15 remain in an inactive stage until the terminal explicitly selects them. Objects are created in persistent memory. Some objects are accessed frequently and the contents of their fields need not the persistent. In that circumstance, the Java card supports transient or temporary objects in RAM. However, once and object has been declared as transient, it's contents cannot be moved back to the persistent memory.

Inside a Java card, the JCRE includes the Java card virtual machine and the classes in 5 the Java card framework. After an applet is correctly loaded into the card's persistent memory and links with the Java card framework and other libraries on the card, JCRE calls the applet's install method as the last step in the applet installation process. A public static method, “install”, must be implemented by an applet class to create an instance of the applet and registered it with JCRE.

Since any given applet on a smart card remains inactive until it is explicitly selected, it is necessary for the terminal to send a “SELECT APDU” command to JCRE. In turn, JCRE suspend the currently selected applet and invokes that applet's “deselect” method to perform any necessary cleanup. JCRE then marks the applet specified in the “SELECT APDU” command as the currently selected applet and then calls the newly selected applet's “select” method. This associated “select” method prepares the applet to accept APDU commands. JCRE dispatches the subsequent APDU commands to the currently selected applet until it receives the next “SELECT APDU” command.

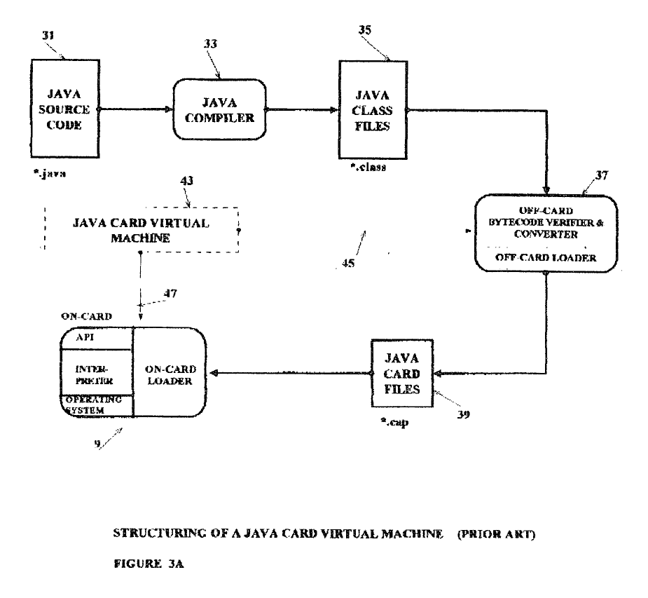

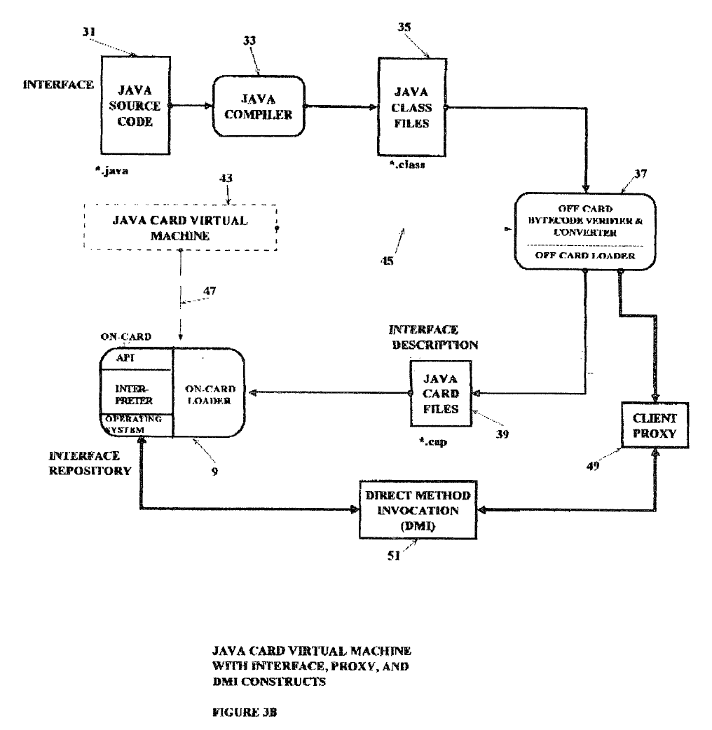

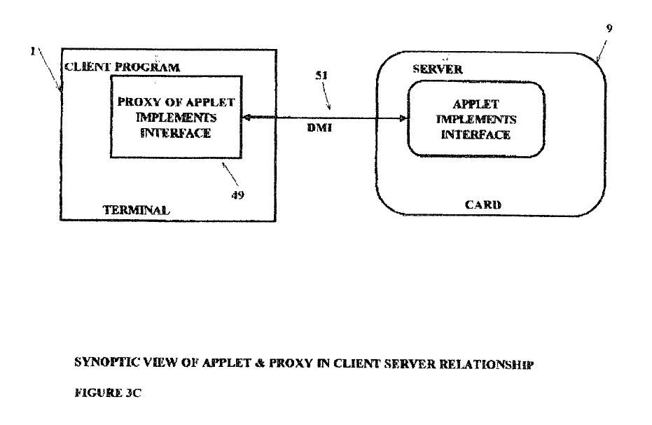

Referring now to FIG. 3A, there a shown a control flow descriptive of processing Java source code 31 into components resident at a terminal (off-card) and those components resident on a card. Applets and applications written in the Java source code are applied to a Java compiler 33 and ancillary libraries (not shown) for producing Java classes in the form of Java class files 35. In object-oriented programming a class contains a collection of methods and variables and relationships for performing one or more functions in the form of specific Instances or objects responsive to invocations in the form of messages or the like.

Java class files 35 are parsed according to their function by a byte code verifier and converter 37 and applied either to the terminal or into the persistent memory of the card by a way of an on card loader. Functionally, a verifier checks that a class file 35 is a valid Java class file. Also, a loader causes the classes to be placed into the system. An interpreter such as on card 9 executes an applet or an application on a terminal because a bytecode verifier is complex, it cannot fit in the limited SmartCard memory. Thus, it is relegated as an forward or terminal function. After verification, class files are processed for name resolution, some linking, and some bytecode optimization All the class files are then rendered into a single downloadable file for transfer to the card especially.

Distributed Systems, Method Invocations, and Java Card Based Applications

In the client/sever model the client invokes applets at the server by a way of command APDU's. The server processes the request message and sends a reply via a response APDU. This process requires applications to include specially designed code to treat low-level string byte packets The general, solution has been to design an application protocol defined or communications between clients and servers, an interface description for providing a list of server procedures which may be called by the client, and “stubs” generated by this interface to build the messages to be exchanged.

In the Java card client server model, the Remote Procedure Call (RPC) is the mechanism, which has been used to abstract the communication interface to the level of a procedure call. Request messages are regarded as procedure calls from a client application, and reply messages are regarded as return values from a server, the server executing the procedure body. In a manner similar to a regular or local procedure call, an RPC is a synchronous operation requiring the requesting program to be suspended until the results of the remote procedure are return.

Generally, RPC is a protocol that one program can use to request a service from another the program located in another computer without having to understand the communication details. Instead of working directly with communication packets, a local process operates as if it were calling a local procedure. In fact, the arguments of the call are packaged and shipped off to the remote target of the call. In this regard, RPC protocols encode arguments and return values using a language neutral and machine independent data representation.

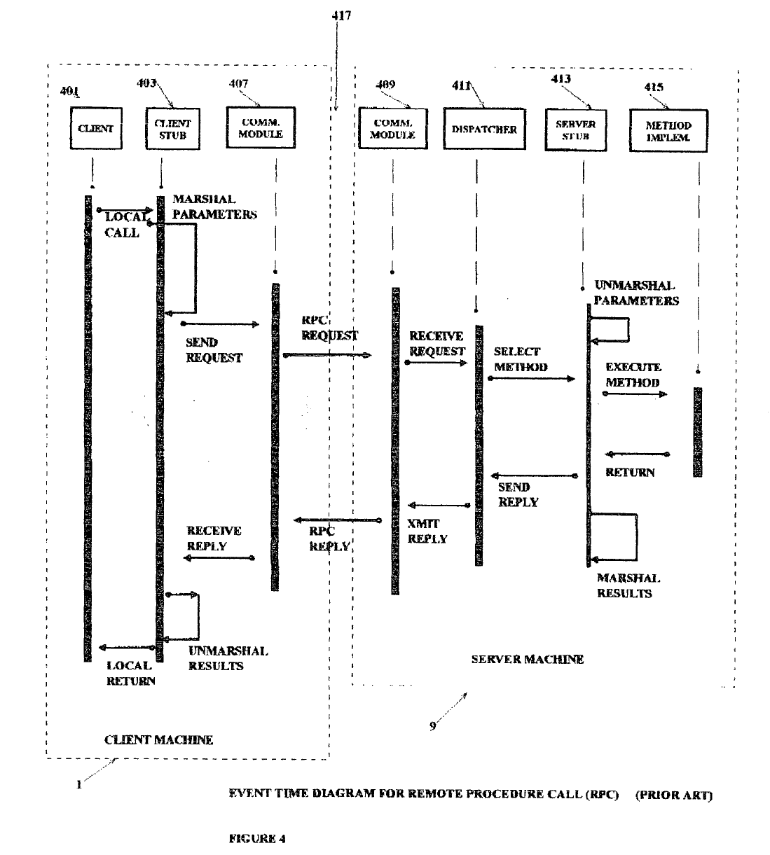

Referring now to FIG. 4, there a shown an event time diagram for RPC as applied to a client/server system such as the Java SmartCard and terminal. At the client's machine 1, the principal objects and constructs include a client application 401, a client stub 403, at a communications module/interface 407. The server machine smart card 9 has as its principal objects and constructs a communications module/interface 409, a dispatcher 411, a server stub 413, and the method/applet 415 that is being invoked.

In this context, a “stub” is defined as a routine such as a method or class that is least as a place holder, usually containing comments describing a function when it is fully implemented. This enables processes to come back and “fill-in the blanks”. In RPC, stubs perform the functions;,of marshaling, unmarshaling, and format conversion.

When a client 401 invokes a remote method, the client stub 403 running on client machine 1 processes the call. Relatedly, stub 403 packages the parameters to be used by the remote method and causes them to be sent via one or more communication packets to the server 9. At the server, the servers stub 413 unmarshals the parameters, and put event in the correct format for that system, and invokes the requested method. At this point the requested method 415 executes. It then stands in the sets back via the same path, that is, through the stubs.

RPC based systems require specification of all interactions between clients and servers in one or more interfaces. Please interfaces are used to produce stubs. The stubs in turn are combined with the actual application code.

The Invention Comprises an Interface, DMI, and Proxies

In this invention, a card applet is defined by a Java interface. The interface specifies the methods provided by the card applet that are visible to the card applet's clients. The card applet interface definition is then used as a basis upon which to construct the client stub (proxy) and to provide an applet description to the JCRE. The applet description is used by the proxy and the JCRE for the marshaling and unmarshaling of parameters and results respectively in reference to invocation and execution of the applet. Also, an RPC like communications protocol, namely, “direct method invocation” (DMI) is for transporting calls and returns as request and reply messages exchanged between the terminal application and the smart card. That is, the interface provides an implementation independent description of an object. The L)MI constitutes a protocol to transport method invocations between client applications and remote objects. Lastly, the proxy is in executable code construct that implements a communications gateway between client applications and remote objects.

The interface is used to provide and implementation independent description of a Java card applet. This is accomplished by describing all methods of the object including the main, the parameter types and the return type, and the exceptions, An example of such a description as expressed in the Java language would be:

```
import javacard.framework.*;
public interface lpurse
{
  int getBalance( );
  void debit(int amount) throws UserException;
  void credit(int amount) throws UserException;
}
```

The Java language reserved words are set out in bold type.

The major restriction is that only simple types are allowed in the interface. For the argument and return is simple types are void, Boolean, byte, short, integer (int), and array (one dimension).

DMI is a protocol for transporting method invocations between client applications and card applets. In this regard, DMI is placed over the standard smart card T=0/T=1 protocol that physically transports the APDU's. Significantly, DMI commands are mapped to APDU commands white DMI responses are mapped to APDU responses.

In the method of this invention a request to a card applet is an invocation of a method declared by its interface. DMI is a mechanism to (1) marshal method invocation parameter values and (2) marshal method return values in the APDU responses. The DMI protocol has only one command, namely, “InvokeMethod(INS byte 36h)”.

An applet proxy in this invention is an object method that implements the applet interface as a communication gateway between client applications and the smart card applet. Thus, each Java call to the Java card applet proxy is converted into a DMI sent to the card and each DMI received by the card is converted into a Java call onto the Java card applet.

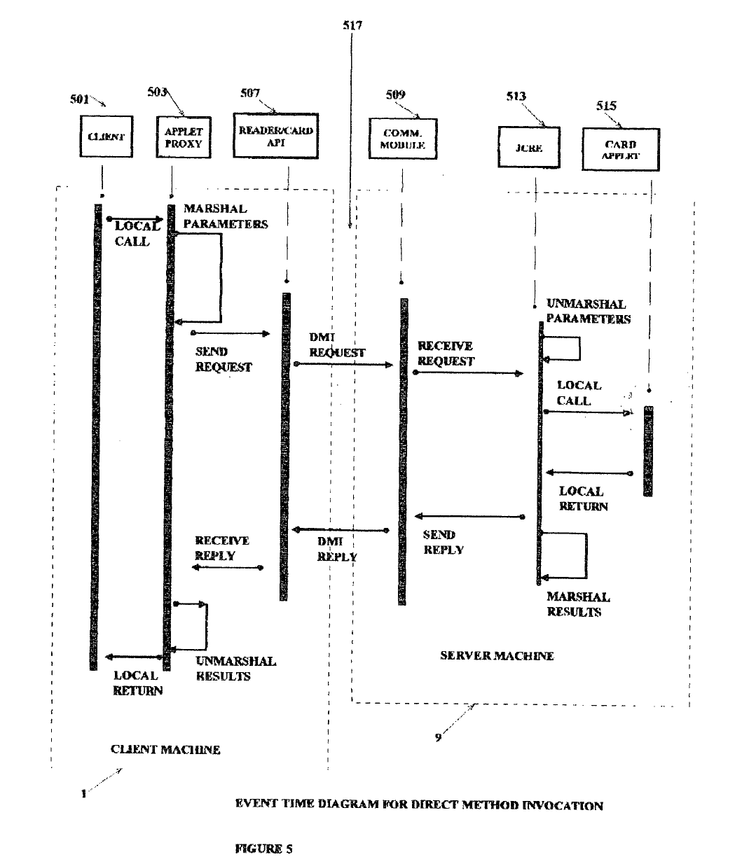

Referring now to FIG. 5, there is shown an event time diagram for direct method invocation (DMI) as applied to a client/server system such as the Java smart card and terminal according to the invention. At the client's machine or terminal 1, the principal objects and constructs include a client application 501, an applet proxy 503, and an application program interface (API) 507. The server machine smart card has as its principal objects and constructs a communications module 509, the Java card run-time environment (JCRE) 513, and a requested card applet 515.

First, it is necessary to create a card applet proxy 503 as an instantiation of a utility (interface description) in the applet class of interest over standard communicating API's 507. From a client application point of view, the code needed to communicate with the card applet 515 is encapsulated in the proxy. Second, a client application 501 invokes methods to interest through the proxy 503. That is, the proxy 503 prepares a DMI invoke message with the parameter values provided by the client application Next the proxy sends this DMI message to the Java card 9 through the API 507, communication module 509 to the JCRE 513. The JCRE unmarshals the parameters and invokes the methods of the applet 515 with a local call After execution of the methods, the results are marshaled and the JCRE prepares a DMI reply message and send the return as a DMI reply over the inverse path to the applet proxy 503 at the client machine 1.

### ILLUSTRATIVE EXAMPLE

Given the following interface and applet class descriptions in Java programming language involving a simple increment or decrement of values in a counter:

The Interface source code:

```
import javacard.framework.*;
public interface lcounter
{
  public static final short NEGATIVE_VALUE = 1;
  public int read( );
  public int increment (int amount)
    throws UserException;
  public int decrement(int amount)
    throws UserException;
}
```

The applet class source code:

```
import javacard.framework.*;
public class Counter extends Applet implements lcounter {
  private int value;
  public Counter( ) { value = 0; }
  public int read( ) { return value ; }
  public int increment (int amount) throws UserException {
    if (amount < 0) throw new UserException(NEGATIVE_VALUE);
    value += amount;
    return value;
  }
  public int decrement (int amount) throws UserException {
    if (amount < 0 || value - amount < 0)
      throw new UserException(NEGATIVE_VALUE);
    value += amount;
    return value;
  }
}
```

The client application as expressed in Java code for the above interface and applet is:

```
  CardReader reader = new new Gcr410 (SERIALPORT.G_COM1);
GxCard card = new GxCard(reader);
try {
  // Opens a session with a card through a reader
  reader.connect( );
  AnswerToReset atr = card.connect( );
  // Communications with the <<Counter>> applet via its proxy
  lcounter counter = new ProxyCounter(card);
  counter.select( );
  System.out.println( “Counter's value = “ +
  counter.decrement ( 100 ) );
  // Termination of the connection
  card dispose( );
  reader.dispose( );
} catch (UserException e1 ) {
    System.out.println(“UserException: “ + e1.getReason( ));
} catch (Exception e2 ) {
    Sytem.out.println( “ Problem: “ + e2.getMessage( ));
}
```

Referring now to FIG. 3B, there is shown the Java card virtual machine with interface, proxy and DMI constructs, In this regard, the difference over the code compilation process as depicted in FIG. 3A is the creation of a proxy 49 resident at the terminal and the DMI invocation 51.

In the above example when taken together with FIGS. 3B and 3C, it should be appreciated that the client application makes a reference to a local object (the proxy) The proxy in turns represents the remote object (the card applet) and then uses this local object to call the remote object, by invoking methods defined in the applets interface. A specific protocol (DMI) between the host and the card is used for this purpose The DMI protocol is manifested by the card operating system on the server side and by an automatically generated proxy program on the client side.

While the invention has been described oath respect to an illustrative embodiment thereof, it will be understood that various changes may be made in the method and means herein described without departing from the scope and teaching of the invention Accordingly, the described embodiment is to be considered merely exemplary and the invention is not to be limited except as specified in the attached claims.

1. A method for managing information exchanges among communicating objects in an objects oriented client server system, said system including first and second object oriented virtual machines running on counterpart first and second computers in respective server and client roles, and a communication path connection between said computers, said server virtual machine having a run-time environment, the method comprising the steps of:
(a) generating a local object at the client machine operable as a proxy to a remote object resident at the server machine;
(b) referencing the local object by an application executing at the client machine and causing the local object to marshal parameters and send a process level call request to the server machine;
(c) responsive to said request by the server machine's run time environment, said run time environment causing the parameters in the request to become unmarshaled, said remote object to be executed, the results of the execution marshaled, and a process level return sent to the client machine; and
(d) responsive to said reply by the local object operable as a proxy, unmarshaling the results from said reply.

2. The method according to claim 1, wherein said process call level requests and replies are generated in an alternating manner.

3. The method according to claim 1, wherein the local object when operating as a proxy at the client machine and the run-time environment when operating at the server machine perform respectively as stubs.

4. A method for managing information exchanges between an application executing at a object oriented virtual machine operable as a client and a remote object resident at another object oriented virtual machine operable as a server, said server machine having a run-time environment, said client and server having a communication path connection there-between, said communication path connection being operable under a process for originating and sending byte level messages therebetween, comprising the steps of:
(a) providing a local object resident at the client machine operable as a proxy stub to the remote object and providing a description of the remote object to enable said run-time environment to also operate as a stub;
(b) responsive to a client application call to the local object, marshaling parameters and causing a process level call request to be sent to the remote object at the server machine, said sending of the request further including mapping said process level call request into counterpart byte string level messages and transmitting said messages to the server machine;
(c) responsive to said request messages by the server machine's run-time environment, mapping said messages into a process level call request, unmarshaling the parameters, invoking and executing the remote object, marshaling the results, forming a process level reply, mapping said reply into string byte messages, and transmitting said reply messages to the client machine; and
(d) responsive to the reply messages by the proxy at the client machine, mapping said reply messages into a process level reply, and unmarshaling the results.

5. The method according to claim 4, wherein said object-oriented virtual machines include Java virtual machines, and further wherein the remote object is an applet, and the local object is an interface description.

6. An article of manufacture comprising a machine readable memory having stored therein a plurality of processor executable control program steps for managing information exchanges among communicating objects in an objects oriented client server system, said system including first and second object oriented virtual machines running on counterpart first and second computers in respective server and client roles, and a communication path connection between said computers, said server virtual machine having a run-time environment, said control program steps include:
(a) a control program step for generating a local object at the client machine operable as a proxy to a remote object resident at the server machine;
(b) a control program step for referencing the local object by an application executing at the client machine and causing the local object to marshal parameters and send a process level call request to the server machine;
(c) a control program step for responsive to said request by the server machine's run time environment, said run time environment causing the parameters in the request to become unmarshaled, said remote object to be executed, the results of the execution marshaled, and a process level return sent to the client machine; and
(d) a control program step for responsive to said reply by the local object operable as a proxy, unmarshaling the results from said reply.
